(19) United States
(12) Patent Application Publication
(10) Pub. No.: US 2005/0105963 A1
(43) Pub. Date: May 19, 2005

(54) Connecting device for display structures

(76) Inventor: Dario Luigi Maniezzo, Romano D'Ezzelino (VI) (IT)

Correspondence Address: RATNERPRESTIA, P O BOX 980, VALLEY FORGE, PA, 19482-0980, US

(21) Appl. No.: 10/497,776

(22) PCT Filed: Nov. 22, 2002
(86) PCT No.: PCT/EP02/13171

(30) Foreign Application Priority Data
Dec. 4, 2001 (IT) PD2001A000283

(51) Int. Cl. F16D 1/00

(52) U.S. Cl. 403/289

(57) ABSTRACT

A connecting device for display structures. The device has a sleeve which can be arranged around an element of variable cross-section of the display structure, and a for clamping the sleeve onto the element. The clamp has at least one jaw which is movable away from and towards the sleeve and a respective cam which is pivotable in order to bring about this movement. The cam is movable along a radial axis of the sleeve in order to vary the position of the jaw in dependence on the cross-section of the element.

### TECHNICAL FIELD OF THE INVENTION

The present invention relates to a connecting device for display structures.

### BACKGROUND OF THE INVENTION

The invention is for application in particular but not exclusively in the setting-up of sectional display structures in which tubular elements are used, which have different cross-sections along their length. This is typically the case in the self-supporting pillars which are widely used in this field. In fact, by virtue of their telescopic structure, these pillars can be adapted to fit rooms of different heights by being extended under pressure, for example, between the floor and the ceiling.

Although, on the one hand, the telescopic structure of the self-supporting pillars permits the above-described versatility of use, on the other hand, it requires the use of connecting devices which can be adapted to the different cross-sections of the pillars so as not to detract from the versatility which is required of structures of this type. Devices of this type, the function of which is to constitute the support and connecting points for transverse elements of the display structure such as connecting shelves or frames are known, for example, from the applicant's commercial production; such a device comprises a sleeve which is arranged around a pillar and is slidable along the length thereof, as well as a mechanism for clamping the sleeve onto the pillar. To satisfy the above-described functional requirements, the clamping mechanism comprises a pair of opposed jaws which are movable radially against the pillar by a screw. However, these clamping mechanisms are rather impractical in use and are not very pleasing aesthetically.

### SUMMARY OF THE INVENTION

The main object of the present invention is to provide a connecting device for display structures which is designed structurally and functionally to overcome the limitations set out above with reference to the prior art mentioned.

Within the scope of this object, a further object of the invention is to provide a device of relatively low weight and pleasing appearance.

These objects are achieved by the present invention by providing a connecting device as described below.

### BRIEF DESCRIPTION OF THE DRAWINGS

The characteristics and the advantages of the invention will become clearer from the detailed description of a preferred embodiment thereof which is described by way of non-limiting example with reference to the appended drawings, in which:

FIG. 1 is a perspective view, from above, of a connecting device for display structures formed in accordance with the present invention,

FIGS. 2 and 3 are a plan view and a front view of the device of FIG. 1, respectively,

FIG. 4 is a section taken on the line IV-IV of FIG. 3, and

FIG. 5 is a section similar to FIG. 4, through a detail of the device of FIG. 1.

### PREFERRED EMBODIMENTS OF THE INVENTION

In the drawings, a connecting device for display structures formed in accordance with the present invention is generally indicated 1.

The device 1 comprises an openable sleeve 1a including a pair of shells 2, 3 which have facing concavities and are articulated to one another at respective first ends, for pivoting about an axis X. At respective opposite, free ends 2a, 3a, the shells 2, 3 comprise an engagement structure and a complementary engagement structure 4, respectively, to permit, alternatively, closure or opening of the sleeve 1a.

Preferably, the engagement structure and the complementary engagement structure 4 are of the snap-engagement type and comprise a pair of substantially parallel hooks 5 projecting from the end 2a and housed releasably in respective seats 6 defined in the end 3a of the shell 3. The seats 6 are shaped so as to engage the hooks 5, preventing them from slipping out accidentally. Moreover, the hooks are urged into engagement in the respective seats 6 by a resilient member, not shown in the appended drawings, and are opened by a push-button 7.

The shape of the shells 2, 3 is such that, when the device 1 is pivoted to the closure position (FIG. 2), a central through-hole 8 of circular cross-section is defined between them and can house an element of similar cross-section, for example, a self-supporting pillar of a display structure (not shown).

In order to fix the sleeve 1a firmly in the desired position on the element, the device 1 comprises a clamp 10 including two jaws, both indicated 11, each housed in a respective seat 12 formed in a central position in a respective shell 2, 3. The jaws 11 are arranged symmetrically so as to face one another when the sleeve 1a is in the closed position and are slidable away from and towards the sleeve 1a, within the respective seats 12, along a radial axis Y, thus defining an extended position and a retracted position in which they project to a greater or to a lesser extent from the shell 2, 3. Each jaw 11 is urged resiliently into the retracted position by a resilient member (not shown) housed in the seats 12 and acting between the jaw and the sleeve 1a. The clamp 10 further comprises, for each jaw 11, a cam 14 which is in abutment with the jaw and is articulated on a pin 15 for pivoting about a respective axis Z parallel to the axis X. When the cam 14 pivots about the axis Z, its eccentricity leads to radial movement of the jaw 11 in abutment therewith, towards the extended position.

To facilitate the pivoting of the cam 14, an operating lever 16 extends therefrom on the side remote from the jaw 11. When the jaw 11 is moved to the extended position by the cam 14, the lever 16 is advantageously housed in a seat 17 defined within the profile of the respective shell 2, 3.

With particular reference to FIG. 2, it should be noted that the shells 2 and 3 have enlarged cross-sections in their central portions in which the clamp 10 is disposed, whereas they have narrower cross-sections in their end regions. The device 1 thus retains a fairly low overall weight, adopting a substantially elliptical outer shape.

Engagement structures are also provided on the device 1 for the connection of fittings, for example, shelves or transverse bars of the display structure, to the sleeve 1a. These engagement structures comprise recesses 18 with dovetail-shaped cross-sections, formed in the shells 2 and 3, respectively, and extending parallel to the axis X. All of the recesses 18 are open at the same end of the sleeve 1a but are closed at the opposite end.

It should be noted that the recesses 18 are arranged in mutually facing positions between the clamp 10 and the ends of the shells 2, 3 so as to permit better balancing of any loads applied to the device 1.

According to a main characteristic of the invention, each cam 14 is movable relative to the respective shell 2, 3 along a radial axis of the sleeve 1a between a first operative position and a second operative position. For this purpose, guides for the cam 14 are provided on each shell 2, 3 and comprise a pair of channels 19 in which the opposite ends of the pin 15 are engaged for sliding.

The shape of the channels 19 is such as to define two pocket-like seats 20a, 20b which are open towards the jaw 11 (FIG. 5) and in which the ends of the pin 15 can come into abutment. The pocket-like seats 20a, 20b are spaced apart radially by a distance H substantially equal to half of the difference between the cross-sections of the element of the display structure on which the device 1 is to be fixed. In particular, for self-supporting pillars of telescopic structure, the distance H will be equal to the difference between the radii of the respective tubular elements.

To mount the connecting device 1 on a display-structure element having different cross-sections the sleeve 1a is arranged around the element by relative pivoting of the shells 2, 3 about the axis X and snap-closure of the engagement structure 4. The cams 14 are then moved to the first operative position or to the second (corresponding to the housing of the pin 15 in the pocket-like seat 20a or 20b, respectively), according to the cross-section of the element at the point at which the device 1 is to be fixed.

This positioning is performed by acting manually on the respective levers 16 in opposition to the resilient member acting on the jaws 11.

The levers 16 are then pivoted about the respective axes Z, leading to corresponding pivoting of the cams 14 and to the movement of the respective jaw 11 to the extended position, against the element. The abutment of the jaw ensures that the device 1 is fixed firmly on the element of the display structure by friction. Once the device 1 has been fixed in the desired position it can support two fittings suitably engaged in the recesses 18.

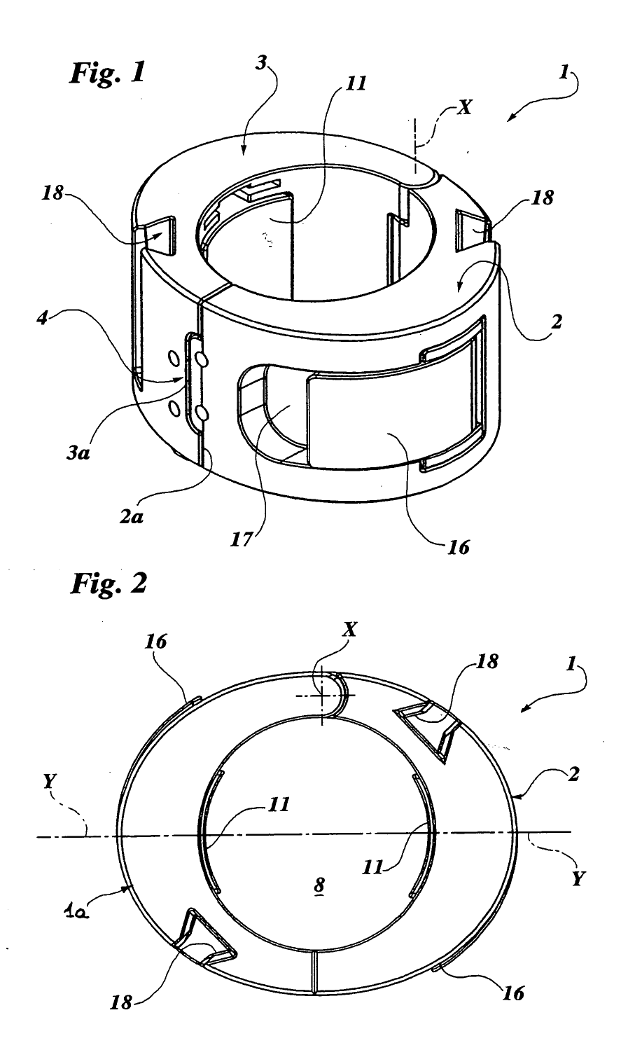

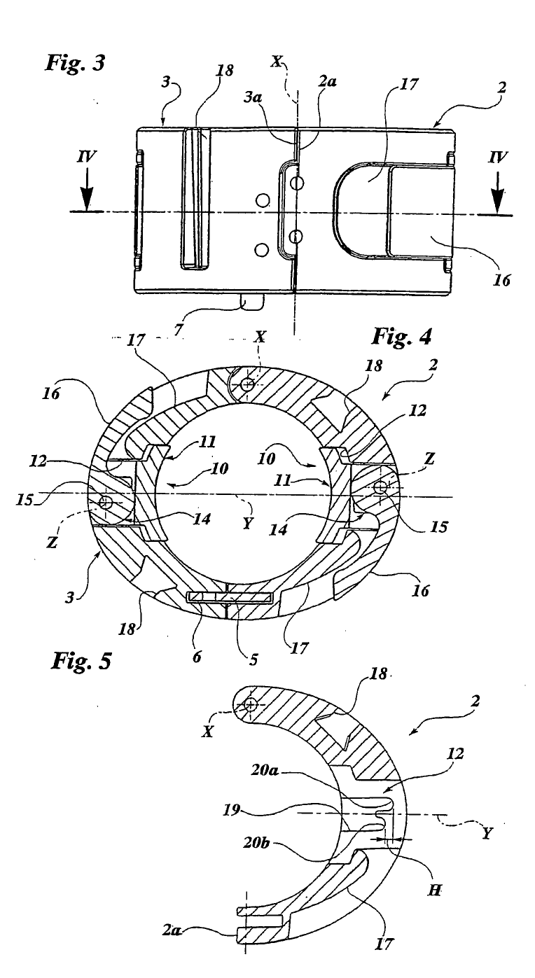

It should be noted that, as a result of the pivoting of the levers 16 to the position for closure of the jaws 11, the levers are housed in the seats 17, within the profile of the sleeve, thus limiting the possibility of accidental knocks (FIGS. 1 and 2).

To dismantle the device 1 it suffices to lift the levers 16 so that the respective jaws 11 are returned to the retracted position (which is also facilitated by the action of the resilient member). The sleeve 1a can then be opened by acting on the push-button 7. In the preferred embodiment described above, the device 1 is designed for adaptation to two different cross-sections of the element of the display structure, but the principle upon which the invention is based can clearly also be used to produce connecting devices for coupling with elements having three or more different cross-sections, by the provision of an adequate number of suitably spaced-apart pocket-like seats.

The present invention thus achieves the objects proposed, combining considerable practicality of use with good adaptability for fitting in display structures. A further advantage of the invention is the attractive overall aesthetic effect which is also enhanced by the elliptical shape.

1. A connecting device for display structures having an element of variable cross-section, the device comprising:
a sleeve adapted to be arranged around the element of variable cross-section of the display structure and having a radial axis, and
a clamp for clamping the sleeve onto the element, the clamp including at least one jaw, which is movable away from and towards the sleeve, and a respective cam which is pivotable in order to bring about movement of the at least one jaw away from and towards the sleeve, the respective cam being movable along the radial axis of the sleeve in order to vary the position of the at least one jaw in dependence on the cross-section of the element.

2. The device according to claim 1 in which two of the said jaws are arranged symmetrically and opposite one another, and each respective cam is movable between a first operative position and at least one second operative position which are spaced apart radially by a distance substantially equal to half of the difference between the cross-sections of the element.

3. The device according to claim 2 in which the sleeve has guide means, for the respective cam which has an articulation pin, for guiding the movement of the cam between the first operative position and the at least one second operative position, the guide means comprising at least one channel in which the articulation pin of the cam is slidably engaged.

4. The device according to claim 1 in which the clamp comprises an operating lever extending from the respective cam in order to bring about pivoting thereof.

5. The device according to claim 4 in which the sleeve has a profile and the operating lever is housed substantially within the profile of the sleeve.

6. The device according to claim 1 in which the sleeve is adapted to be closed releasably around the element, the sleeve comprising two shells which are articulated to one another at a first end, and engagement means and complementary engagement means which are arranged at the opposite ends of the two shells, respectively.

7. The device according to claim 6 in which the engagement means and the complementary engagement means are of the snap-engagement type.

8. The device according to claim 6 in which the clamp is arranged symmetrically on the shells in a central positions relative to the ends.

9. The device according to claim 8 in which the sleeve has a symmetrically enlarged cross-section in the region of the clamp and a symmetrically narrower cross-section in the region of the ends.

10. A connecting device for display structures having an element of variable cross-section, the device comprising:
a sleeve adapted to be arranged around the element of variable cross-section of the display structure and having a radial axis; and
a clamp for clamping the sleeve onto the element, the clamp including:
(a) two jaws arranged symmetrically and opposite one another and movable away from and towards the sleeve,
(b) a respective cam which is pivotable in order to bring about movement of the jaws away from and towards the sleeve, the respective cam being movable along the radial axis of the sleeve in order to vary the position of the jaws depending on the cross-section of the element and being movable between a first operative position and at least one second operative position which are spaced apart radially by a distance substantially equal to half of the difference between the cross-sections of the element, and
(c) an operating lever extending from the respective cam in order to bring about pivoting thereof.

11. The device according to claim 10 in which the sleeve has guide means, for the respective cam which has an articulation pin, for guiding the movement of the cam between the first operative position and the at least one second operative position, the guide means comprising at least one channel in which the articulation pin of the cam is slidably engaged.

12. The device according to claim 10 in which the sleeve has a profile and the operating lever is housed substantially within the profile of the sleeve.

13. The device according to claim 10 in which the sleeve is adapted to be closed releasably around the element, the sleeve comprising two shells which are articulated to one another at a first end, and engagement means and complementary engagement means which are arranged at the opposite ends of the two shells, respectively.

14. The device according to claim 13 in which the engagement means and the complementary engagement means are of the snap-engagement type.

15. The device according to claim 13 in which the clamp is arranged symmetrically on the shells in a central position relative to the ends.

16. The device according to claim 15 in which the sleeve has a symmetrically enlarged cross-section in the region of the clamp and a symmetrically narrower cross-section in the region of the ends.

17. A connecting device for display structures having an element of variable cross-section, the device comprising:
a sleeve being adapted to be arranged and closed releasably around the element of variable cross-section of the display structure, having a radial axis, and comprising two shells which are articulated to one another at a first end and engagement means and complementary engagement means which are arranged at the opposite ends of the two shells, respectively; and
a clamp for clamping the sleeve onto the element, the clamp including:
(a) two jaws arranged symmetrically and opposite one another and movable away from and towards the sleeve, and
(b) a respective cam which is pivotable in order to bring about movement of the jaws away from and towards the sleeve, the respective cam being movable along the radial axis of the sleeve in order to vary the position of the jaws depending on the cross-section of the element and being movable between a first operative position and at least one second operative position which are spaced apart radially by a distance substantially equal to half of the difference between the cross-sections of the element.

18. The device according to claim 17 in which the sleeve has guide means, for the respective cam which has an articulation pin, for guiding the movement of the cam between the first operative position and the at least one second operative position, the guide means comprising at least one channel in which the articulation pin of the cam is slidably engaged.

19. The device according to claim 17 in which the clamp comprises an operating lever extending from the respective cam in order to bring about pivoting thereof, the sleeve has a profile, and the operating lever is housed substantially within the profile of the sleeve.

20. The device according to claim 17 in which the engagement means and the complementary engagement means are of the snap-engagement type, the clamp is arranged symmetrically on the shells in a central position relative to the ends, and the sleeve has a symmetrically enlarged cross-section in the region of the clamp and a symmetrically narrower cross-section in the region of the ends.
